(19) United States
(12) Patent Application Publication
(10) Pub. No.: US 2025/0066159 A1
(43) Pub. Date: Feb. 27, 2025

(54) ELEVATOR SYSTEM AND METHOD FOR OPERATING

(71) Applicant: KONE Corporation, Helsinki (FI)

(72) Inventors: Ari Jussila, Helsinki (FI); Toni Hirvonen, Helsinki (FI); Atso Koskinen, Helsinki (FI)

(73) Assignee: KONE Corporation, Helsinki (FI)

(21) Appl. No.: 18/944,937

(22) Filed: Nov. 12, 2024

Related U.S. Application Data
(63) Continuation of application No. PCT/EP2022/066446, filed on Jun. 16, 2022.

(51) Int. Cl. B66B 5/04; B66B 3/02; B66B 19/06

(52) U.S. Cl. CPC B66B 5/044; B66B 3/02; B66B 19/06

(57) ABSTRACT

An elevator system includes a hoistway with marking objects arranged at predetermined positions in the hoistway, an elevator car with a sensor providing an indication when the elevator car has reached the position a marking object, a complementary positioning system providing a complementary indication of the position of the elevator car in the hoistway, and a controller receiving the indication and the complementary indication. In order to minimize a need for manual inspections, the controller includes a memory maintaining for each marking object a setup position, and during elevator runs, the controller is configured to calculate an offset for a marking object for which the sensor provides an indication, by comparing the setup position for the marking object in question with the position indicated by the complementary positioning system at the indication of the marking object, and to trigger an alarm if the calculated offset fulfills a predetermined criterion.

### BACKGROUND OF THE INVENTION

### Field of the Invention

This invention relates to an elevator system and to a method for operating an elevator. More precisely, the invention relates to the problem of ensuring that the elevator system is capable of keeping track of the position of an elevator car.

### Description of Prior Art

In order to operate an elevator in a safe way, the elevator system needs to know the location of the elevator car. A previously known solution is to provide the hoistway with marking objects at predetermined positions in the hoistway. A sensor on the elevator car is then capable of detecting and providing an indication when the elevator car has reached the position of a marking object.

As the marking objects and the sensor provide an indication of the position of the elevator car only when the elevator car is located at a marking object, the previously known elevator systems are additionally provided with a complementary positioning system. In this way, the position of the elevator car is known irrespectively where in the elevator hoistway the elevator car is located.

There exists alternative ways of implementing a complementary positioning system. A common problem is, however, that a complementary positioning system is not sufficiently accurate in all situations. Therefore, the complementary positioning system is utilized in combination with the marking objects and the sensor.

Naturally, the exact position of the elevator car in the hoistway is a critical safety issue. Therefore, a lot of effort needs to be put on ensuring that the positioning works correctly. Due to this regular manual inspections are needed.

### SUMMARY OF THE INVENTION

An object of the present invention is to solve the above-mentioned drawback and to provide solution which facilitates automatic monitoring. This object is achieved with an elevator system according to independent claim 1 and a method according to independent claim 11.

By maintaining for each marking object a setup position, and by calculating during elevator runs an offset by comparing the setup position with the position indicated by the complementary positioning system when the indication of the marking object is received, it becomes possible to detect when the calculated offset fulfills a predetermined criterion for triggering an alarm. This facilitates easy and reliable automatic monitoring.

### BRIEF DESCRIPTION OF DRAWINGS

In the following the present invention will be described in closer detail by way of example and with reference to the attached drawings, in which

FIG. 1 illustrates an elevator system,

FIGS. 2 and 3 illustrate a rotating element with an encoder implemented with a hoisting rope pulley of an elevator car, and

FIG. 4 illustrates a rotating element with an encoder implemented with a roller guide of an elevator car.

### DESCRIPTION OF AT LEAST ONE EMBODIMENT

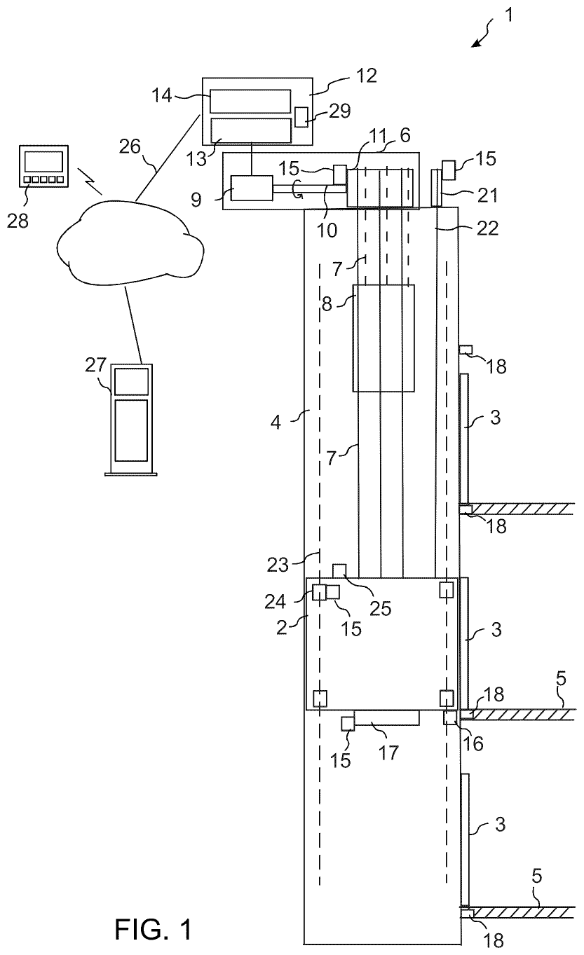

FIG. 1 illustrates an elevator system 1 where a method for operating an elevator can be implemented.

In FIG. 1, an elevator car 2 is moved in a hoistway 4 between landings 3 with doors which are located on different floors 5 of a building, for instance. In the illustrated example the elevator car 2 is moved by a hoisting machine 6 by means of ropes 7. The same ropes are also used to move a counterweight 8 in the hoistway 4.

The hoisting machine 6 comprises an electric motor 9 which via a shaft 10 drives sheave 11 around which the ropes 7 run. In the illustrated example the operation of the elevator system is controlled by a controller 12 comprising one or more components. These components may be arranged in a single device cabinet as illustrated by way of example, or alternatively distributed at different locations around the elevator installation site. The illustrated controller may be implemented by electrical circuits, by one or more processors running a program code or as a combination of these, for instance.

In FIG. 1 the electric motor 9 of the hoisting machine 6 is controlled by a motion controller 13, which may include a plurality of components, including a frequency converter supplying electric power to the electric motor 9. Additionally, in the illustrated example of FIG. 1, the controller 12 may comprises a main safety circuit 14, which may be implemented as a programmable electronic controller running a safety monitoring software monitoring the operation of the entire elevator system, for instance. The main safety circuit 14 may receive signals from a plurality of components in the elevator system 1 and it may control an electromechanical brake of the hoisting machine and emergency brakes, for instance, in order to be able to initiate emergency braking when needed.

In order to be able to move the elevator car 2 correctly in the hoistway 4 during elevator runs, the controller 12, such as the motion controller 13, needs positioning information of the elevator car 2 in the hoistway 4. For this purpose, the elevator system of FIG. 1 is provided with a relative positioning system and with a complementary positioning system.

The relative positioning system comprises a plurality of marking objects 18 arranged at predetermined positions in the hoistway 4. Typically marking objects 18 are arranged at least at the positions of the landings 3. Additionally, marking objects 18 may be arranged at selected locations near end terminals of the elevator hoistway 4 to give an indication of extreme limits for allowable elevator car 2 movement in the elevator hoistway. One alternative is that the marking objects 18 are magnets and that the elevator car is provided with a sensor 16 providing an indication to the controller 12 when the elevator car 2 has reached the position of a magnet. In any case, the relative positioning system provides an indication of the position of the elevator car only when the sensor 16 is located at one of the marking objects 18. At that stage the controller 12 will know at which one of the marking objects 18 the elevator car is located.

In FIG. 1, the marking objects 18 of the landings 3 and the sensor 16 of the elevator car 2 are such positioned that the sensor provides an indication when the floor of the elevator car 2 is correctly aligned, in other words, on the same level as the floor 5 of the landing 3. The motion controller 13 receives the indication from the sensor 16, due to which the elevator car 2 can be stopped at the correct moment to facilitate loading and unloading passengers of the elevator car via a door at the landing 3.

In FIG. 1, the elevator system 1 is by way of example provided with five different complementary positioning systems, though in praxis, it may be sufficient to have only one of the complementary positioning systems at a time provided in an elevator system. Each of the illustrated complementary positioning systems provides a complementary indication of the position of the elevator car 2 to the controller. Consequently, though the relative positioning system provides an indication of the position only when the sensor 16 is located at a marking object 18, due to the additional information from the complementary positioning system the motion controller 13 of the controller 12 can continuously keep track of the position of the elevator car, irrespectively where in the hoistway 4 the elevator car 2 is located.

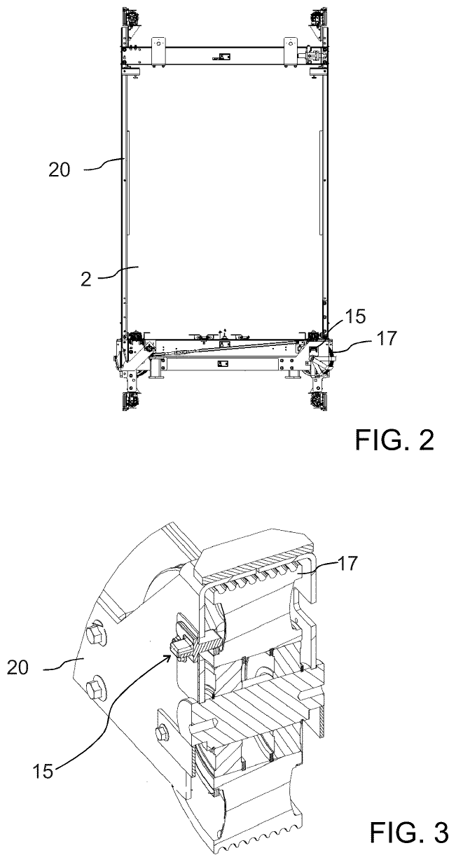

A first complementary positioning system implemented in FIG. 1 includes an encoder 15 in combination with a rotating element in the form of a rope pulley 17 which rotates when the hoisting machine 6 rope 7 and the elevator car 2 moves in the hoistway 4. This first complementary positioning system is indicated in more detail in FIGS. 2 and 3. The bottom of the sling 20 of the elevator car 2 is provided with rope pulleys 17 via which the hosting machine rope is guided. FIG. 3 illustrates one of these rope pulleys in cross-section. The encoder 15 comprises a stationary part attached to the sling 20, for instance, and a movable part rotating with the pulley 17. In case of a magnetic encoder, the moving part may be a magnetic band and the stationary part a magnetic reader. However, also other types of encoders, such as optical, may be utilized. In any case, as the pulley 17 rotates, the encoder provides an indication of the rotation by generating pulses. By counting the number of pulses, the amount of rotation and the distance travelled by the elevator car may be calculated. This calculation may be implemented by the motion controller 13, for instance, in order to provide the controller 12 with the complementary position of the elevator car 2 based on the incremental travel distance indicated by the encoder.

Also the second complementary positioning system implemented in FIG. 1 includes an encoder 15 in combination with a rotating element, however, located in or in connection with the hoisting machine 16. In this implementation the rotating element may be a sheave 11 or a shaft 10 of a hoisting machine 6 which rotates when the electric motor 9 via the shaft 10 rotates the sheave 11 to move the rope 7 and the elevator car 2. Similarly, as explained in connection with FIGS. 2 and 3, the encoder 15 produces pulses which can be calculated to determine the position of the elevator car in the hoistway 4.

Also the third complementary positioning system in FIG. 1 includes an encoder 15 in combination with a rotating element, however, in the form of a rope pulley 21 of an over speed governor. An overspeed governor is utilized to ensure that the speed of an elevator car does not exceed a predefined limit. If so, emergency braking may be triggered. In FIG. 1 the rope 22 of the overspeed governor is connected to the elevator car 2, from where it is guided around the rope pulley 21. Consequently, as the elevator car 2 and the rope 22 move, the pulley 21 rotates. Similarly, as explained in connection with FIGS. 2 and 3, the encoder 15 produces pulses which can be calculated to determine the position of the elevator car in the hoistway 4.

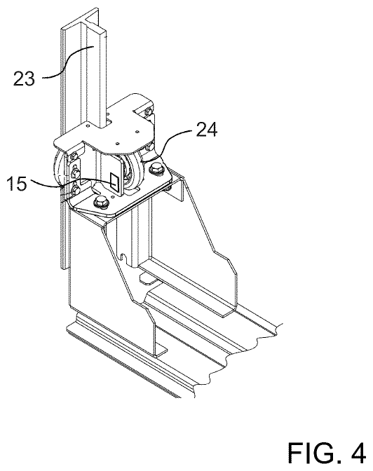

Also the fourth complementary positioning system in FIG. 1 includes an encoder 15 in combination with a rotating element, however, in the form of a roller guide 24 of the elevator car 2. The roller guide 24 is illustrated in more detail in FIG. 4. When the elevator car 2 moves in the hoistway 4, the roller guide 24 rotates due to contact with the guide rails 23 attached to the hoistway 4. Similarly, as explained in connection with FIGS. 2 and 3, the encoder 15 produces pulses which can be calculated to determine the position of the elevator car in the hoistway 4.

Finally, the fifth complementary positioning system in FIG. 1 includes an acceleration sensor provided to the elevator car 2. Consequently, as the elevator car moves, the acceleration sensor 25 may provide a signal to the motion controller 13 in order to provide the controller with a complementary indication of the position of the elevator car 2.

Irrespectively of which one of the above-described complementary positioning systems are in use in an elevator system, there always exists a certain degree of inaccuracy in the complementary indication of the position. The reason is that sliding may occur at the rotating element, such as sliding of the rope 7, 22 in relation to the pulley 17, 21 or sheave 11, or sliding of the roller guide 24 in relation to the guide rail 23. Also some extent of inaccuracy can be expected when an acceleration sensor is used. Therefore, a complementary positioning system needs to be used in connection with a relative positioning system such that the exact position will be known at each moment when the sensor has provided an indication of a marking object, while the position when the elevator car moves between the marking objects is obtained from the complementary positioning system.

However, inaccuracy may occur also for a relative positioning system as one or more of the marking objects 18 may overt time become dislocated, for instance. Alternatively, it is also possible that a marking object brakes down and needs to be replaced.

Due to this, the controller 12 maintains in a memory 29 for each marking object 18 a setup position. During elevator 2 runs the controller 12 is configured to calculate an offset for a marking object 18 for which the sensor 16 provides an indication. The offset is calculated by comparing the setup position for the marking object in question, as obtained from the memory 29, with the position indicated by the complementary positioning system currently used, at the moment when the marking object 18 is indicated. If the marking object 18 has moved, the offset value will indicate how much the marking object has moved compared to the setup position. On the other hand, if the making object has not moved since the setup position, the offset for this marking object will be zero.

In case the calculated offset fulfills a predetermined criterion, such as when the offset value is high and indicates that the marking object has moved a distance larger than allowed compared to the offset value, an alarm will be triggered by the controller 12. At that stage the alarm may be triggered such that further elevator runs with the elevator car are prevented before the elevator in question has been checked by maintenance personnel.

In praxis the elevator system may utilize the calculated offset values also to improve the positioning accuracy though the criterion for triggering an alarm has not been fulfilled. One alternative is that an offset value for a specific marking object 18 is used to evaluate when the elevator car is approaching this marking object. Consequently, instead of assuming that the elevator is at this marking object when the complementary positioning system indicates that the complementary position of the elevator car corresponds to the setup position stored in the memory 29 for this marking object, the last calculated offset value for this marking object may be taken into account. In this way it becomes possible to estimate with a better accuracy, based on the obtained complementary position, when the elevator car arrives to the position of the marking object.

The controller 12 may be configured to store in the memory calculated offset values separately for each marking object 18 also when no alarm has been triggered. In this way, once an alarm is triggered, the controller may process the stored offset values, and based on the result of the processing the alarm may be triggered with an indication of the type of error detected. If a high offset value has been calculated only for one of the marking objects 18 when an alarm is triggered, it is likely that only one of the marking objects 18 has moved a distance longer than allowed. In this case the alarm may be triggered with an indication of a single dislocated marking object 18. However, if a high offset value has been calculated for a plurality of marking objects 18, the alarm may be triggered with an indication an error in the complementary positioning system.

In FIG. 1 it is by way of example assumed the elevator system has an interface 26 to a communication system for transmitting messages to a predetermined receiver which may be located outside of the installation site of the elevator. The communication system may be a wired or wireless communication system such as a mobile communication system, for instance. In that case a triggered alarm may be transmitted from the controller 12 to a remote monitoring center 27 which monitors the operation of a plurality of elevators, for instance. The monitoring center 27 may include a server or utilize a cloud service for storing incoming messages such that maintenance personnel may utilize portable terminals 28, for instance, to check the status of the monitored elevator installations. Alternatively or in addition, the messages with the alarms may be transmitted directly to the terminals 28 of the maintenance personnel, for instance.

In addition to transmitting when an alarm has been triggered, the controller 12 may also in other situations transmit data to the predetermined receiver. One alternative is to regularly transmit information about calculated offset values, in order for maintenance personnel to have this information available when considering and evaluating the maintenance need for the elevator in question.

When the elevator system of FIG. 1 is taken into use for the first time and also after maintenance involving adjustments, it is beneficial to implement a setup procedure to ensure that the setup positions for the marking objects 18 are correctly stored in the memory 29. This may be achieved by during a setup move the elevator car 2 from a position of a marking object to a position where an indication is received by the sensor 16 that the elevator car has reached the position of a following marking object 18. At that stage the complementary indication provided by the used complementary positioning system is received. This position received from the complementary positioning system is then stored as the setup position for the marking object 18 in question. This procedure is then repeated for all marking objects in the hoistway 4 such that the memory 29 contains the correct setup positions for all marking objects as indicated by the complementary positioning system during setup.

It is to be understood that the above description and the accompanying figures are only intended to illustrate the present invention. It will be obvious to a person skilled in the art that the invention can be varied and modified without departing from the scope of the invention.

1. An elevator system comprising:
a hoistway with marking objects arranged at predetermined positions in the hoistway;
an elevator car with a sensor providing an indication when the elevator car has reached the position of a marking object;
a complementary positioning system providing a complementary indication of the position of the elevator car in the hoistway between the marking objects; and
a controller receiving the indication and the complementary indication,
wherein the controller comprises a memory maintaining for each marking object a setup position, and
wherein during elevator runs, the controller is configured to calculate an offset for a marking object for which the sensor provides an indication, by comparing the setup position for the marking object in question with the position indicated by the complementary positioning system at the indication of the marking object, and to trigger an alarm if the calculated offset fulfills a predetermined criterion.

2. The elevator system according to claim 1, wherein the marking objects are magnets.

3. The elevator system according to claim 1, wherein the complementary positioning system comprises a rotating element rotating when the elevator car moves in the hoistway, and an encoder providing an indication of the rotation of the rotating element.

4. The elevator system according to claim 3, where the rotating element is a shaft of a hoisting machine, a rope sheave or a pulley of a hoisting machine rope or of an overspeed governor rope which rotates when the rope moves in the hoistway during an elevator car run, or a roller guide of the elevator car which rotates due to contact with a guide rail in the hoistway during an elevator car run.

5. The elevator system according to claim 1, wherein the complementary positioning system comprises an acceleration sensor provided to the elevator car.

6. The elevator system according to claim 1, wherein the controller triggers an alarm preventing elevator runs with the elevator car if a calculated offset is outside of allowed tolerances.

7. The elevator system according to claim 1, wherein the controller processes offset values calculated for the different marking objects and triggers an alarm with an indication of a dislocated marking object if a high offset value has been calculated only for one of the marking objects.

8. The elevator system according to claim 1, wherein the controller processes offset values calculated for the different marking objects and triggers an alarm with an indication of an error in the complementary positioning system if a high offset value has been calculated for a plurality of marking objects.

9. The elevator system according to claim 1, wherein the elevator system comprises an interface to a communication system for transmitting to a predetermined receiver at least one of triggered alarms and calculated offset values.

10. The elevator system according to claim 1, wherein a marking object is arranged in the hoistway at least in a position of a landing, such that a floor of the elevator car is aligned with a floor of the landing when the sensor provides an indication that the elevator car has reached the position of the marking object of the landing.

11. A method for operating an elevator, comprising:
receiving an indication when an elevator car has reached a position of a marking object; and
receiving an indication of a position of the elevator car from a complementary positioning system, the complementary positioning system sensing the position of the elevator car in the hoistway between the marking objects,
wherein the method comprises the steps of:
maintaining in a memory for each marking object a setup position;
calculating an offset by comparing the setup position for the marking object in question with the position indicated by the complementary positioning system when the indication of the marking object is received; and
triggering an alarm if the calculated offset fulfills a predetermined criterion.

12. The method according to claim 11, wherein the alarm is triggered to indicate a dislocated marking object if a high offset value has been calculated for one marking object only.

13. The method according to claim 11, wherein an alarm with an indication of an error in the complementary positioning system is triggered if a high offset value has been calculated for a plurality of the marking objects.

14. The method according to claim 11, wherein at least one of alarms or calculated offset values are transmitted via an interface and a communication system to a predetermined receiver.

15. The method according to claim 11, wherein the method comprises storing a setup position for a marking object in the memory during a setup by:
moving the elevator car from a position of a marking object to a position where an indication is received that the elevator car has reached the position of a following marking object;
receiving a complementary indication of the position from the complementary positioning system which indicates the position of the elevator car; and
storing the position of the elevator car from the complementary positioning system as the setup position of the marking object in the memory.

16. The elevator system according to claim 2, wherein the complementary positioning system comprises a rotating element rotating when the elevator car moves in the hoistway, and an encoder providing an indication of the rotation of the rotating element.

17. The elevator system according to claim 2, wherein the complementary positioning system comprises an acceleration sensor provided to the elevator car.

18. The elevator system according to claim 3, wherein the complementary positioning system comprises an acceleration sensor provided to the elevator car.

19. The elevator system according to claim 4, wherein the complementary positioning system comprises an acceleration sensor provided to the elevator car.

20. The elevator system according to claim 2, wherein the controller triggers an alarm preventing elevator runs with the elevator car if a calculated offset is outside of allowed tolerances.
